(19) United States
(12) Patent Application Publication
(10) Pub. No.: US 2017/0026421 A1
(43) Pub. Date: Jan. 26, 2017

(54) APPARATUS AND METHOD FOR SUPPORTING BACK-UP AND RESTORE OF ENVIRONMENT FOR PERFORMING A FUNCTION

(71) Applicant: Samsung Electronics Co., Ltd., Gyeonggi-do (KR)

(72) Inventors: Sung Jo OH, Gyeonggi-do (KR); Young Kyoo KIM, Seoul (KR); JeWon LEE, Gyeonggi-do (KR); Sung Kwon JUNG, Gyeonggi-do (KR); Byung Wook CHO, Gyeonggi-do (KR); Jung Hion CHOI, Seoul (KR)

(73) Assignee: Samsung Electronics Co., Ltd.

(21) Appl. No.: 15/218,876

(22) Filed: Jul. 25, 2016

(30) Foreign Application Priority Data
Jul. 24, 2015 (KR) 10-2015-0105092

(51) Int. Cl. H04L 29/06; H04W 12/08; H04L 29/08; H04W 4/00; H04W 8/18

(52) U.S. Cl. CPC H04L 63/205; H04W 4/001; H04W 8/18; H04L 67/02; H04W 4/008; H04W 12/08; H04L 63/102; H04L 63/08; H04L 67/1095

(57) ABSTRACT

An electronic device is provided. The electronic device includes a memory having a first memory area for storing an instruction that provides a normal operating mode and a second memory area for storing an instruction that provides a secure operating mode, and a processor configured to implement a secure mode management module that is configured to receive configuration information associated with the secure operating mode from at least one external electronic device and to store at least one function corresponding to the configuration information in the second memory area.

### PRIORITY

This application claims priority under 35 U.S.C. §119(a) to Korean Patent Application Serial number 10-2015-0105092, which was filed on Jul. 24, 2015 in the Korean Intellectual Property Office, the entire disclosure of which is incorporated herein by reference.

### BACKGROUND

1. Field of the Disclosure

The present disclosure relates generally to performing a function in an electronic device, and more particularly, to an apparatus and method for supporting back-up and restore of an environment of one electronic device to another electronic device.

2. Description of the Related Art

A mobile device (e.g., a smartphone, a tablet, or the like) supports backup and restore functions based on a user account. For example, a user of the smartphone may backup applications currently installed in a smartphone, data stored therein, environment configuration information, and the like to a personal computer (PC) or cloud server. In the case where a user's smartphone is initialized (e.g., factory reset, format, or the like) or in the case where the user purchases a new device, the user downloads the backup data into the new device to restore a previously used environment.

Meanwhile, a technology that provides an environment, in which a plurality of programs installed in distinguishable areas (e.g., a container) of memory areas are executable to be distinguishable from a general use environment, is now applied to an electronic device like a smartphone.

Various applications may be installed in an electronic device. Furthermore, a variety of personal information may be stored in the electronic device, and one or more e-mail and/or social network accounts may be used with the electronic device. In the case where a user formats the electronic device being currently used or replaces the electronic device with another electronic device, the user may back up the previous environment and may restore the backup environment on a new (or initialized) electronic device. However, such a process can typically be complicated, as the environment can include security policy configuration, device setting, application installation, account setup, and data synchronization.

### SUMMARY

Aspects of the present disclosure have been made to address at least the above-mentioned problems and/or disadvantages and to provide at least the advantages described below. Accordingly, an aspect of the present disclosure is to provide a method for backing up or restoring an existing use environment by using configuration information (e.g., a profile), and an apparatus using the method.

In accordance with an aspect of the present disclosure, there is provided an electronic device. The electronic device includes a memory having a first memory area for storing an instruction that provides a normal operating mode and a second memory area for storing an instruction that provides a secure operating mode and a processor configured to implement a secure mode management module that is configured to receive configuration information associated with the secure operating mode from at least one external electronic device and to store at least one function corresponding to the configuration information in the second memory area.

In accordance with another aspect of the present disclosure, there is provided an electronic device. The electronic device includes a communication module configured to receive configuration information associated with at least one control operating mode from an external electronic device and a processor configured to control a control mode management module that is configured to provide at least one function corresponding to the configuration information if a resource of the electronic device satisfies the configuration information and to provide the at least one function based on one of the resource and the configuration information if the resource of the electronic device does not satisfy the configuration information.

In accordance with another aspect of the present disclosure, there is provided a method of an electronic device. The method includes executing a container for an operating environment of the electronic device, obtaining configuration information associated with the container from an external electronic device, and configuring the operating environment of the container based on the configuration information.

In accordance with another aspect of the present disclosure, there is provided a non-transitory computer-readable recording medium having recorded thereon an instruction, the instruction, when executed by an electronic device, performing a method, the method including executing a container for an operating environment of the electronic device, obtaining configuration information associated with the container from an external electronic device, and configuring the operating environment of the container based on the configuration information.

### BRIEF DESCRIPTION OF THE DRAWINGS

The above and other aspects, features, and advantages of certain embodiments of the present disclosure will be more apparent from the following detailed description taken in conjunction with the accompanying drawings, in which:

FIG. 1 is a diagram illustrating an environment for backing up and restoring configuration information (e.g., a container profile), according to an embodiment of the present disclosure;

FIG. 2 is a diagram illustrating architecture of a terminal in which at least one control mode is set by using configuration information, according to an embodiment of the present disclosure;

FIG. 3 is a diagram illustrating an execution screen of a control mode, according to an embodiment of the present disclosure;

FIG. 4 is a flowchart of a method for configuring a configuration information template, according to an embodiment of the present disclosure;

FIG. 5 is a flowchart of a method for applying configuration information, according to an embodiment of the present disclosure;

FIG. 6 is a diagram illustrating screens in which configuration information is applied, according to an embodiment of the present disclosure;

FIG. 7 is a flowchart of a method for converting a web app to a local application, according to an embodiment of the present disclosure;

FIG. 8 is a flowchart of a method for converting a local application to a web app, according to an embodiment of the present disclosure;

FIG. 9 is a diagram illustrating screens for converting a web app to a local based application, according to an embodiment of the present disclosure;

FIG. 10 is a diagram illustrating configuration information being synchronized based on an account at different electronic devices, according to an embodiment of the present disclosure;

FIG. 11 is a diagram illustrating an electronic device in a network environment, according to an embodiment of the present disclosure;

FIG. 12 is a diagram illustrating an electronic device, according to an embodiment of the present disclosure; and

FIG. 13 is a diagram illustrating a program module, according to an embodiment of the present disclosure.

Throughout the drawings, it should be noted that like reference numbers are used to depict the same or similar elements, features, and structures.

### DETAILED DESCRIPTION

Embodiments of the present disclosure will be described herein below with reference to the accompanying drawings. However, the embodiments of the present disclosure are not limited to the specific embodiments and should be construed as including all modifications, changes, equivalent devices and methods, and/or alternative embodiments of the present disclosure.

The terms and words used in the following description and claims are not limited to their dictionary meanings, but are merely used to enable a clear and consistent understanding of the present disclosure. Accordingly, it should be apparent to those skilled in the art that the following description of various embodiments of the present disclosure is provided for illustrative purposes only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms “have,” “may have,” “include,” and “may include” as used herein indicate the presence of corresponding features (for example, elements such as numerical values, functions, operations, or parts), and do not preclude the presence of additional features.

The terms “A or B,” “at least one of A or/and B,” or “one or more of A or/and B” as used herein include all possible combinations of items enumerated with them. For example, “A or B,” “at least one of A and B,” or “at least one of A or B” means (1) including at least one A, (2) including at least one B, or (3) including both at least one A and at least one B.

Terms such as “first” and “second” as used herein may modify various elements regardless of an order and/or importance of the corresponding elements, and do not limit the corresponding elements. These terms may be used for the purpose of distinguishing one element from another element. For example, a first user device and a second user device may indicate different user devices regardless of the order or importance. For example, a first element may be referred to as a second element without departing from the scope the present invention, and similarly, a second element may be referred to as a first element.

It will be understood that, when an element (for example, a first element) is “(operatively or communicatively) coupled with/to” or “connected to” another element (for example, a second element), the element may be directly coupled with/to another element, and there may be an intervening element (for example, a third element) between the element and another element. To the contrary, it will be understood that, when an element (for example, a first element) is “directly coupled with/to” or “directly connected to” another element (for example, a second element), there is no intervening element (for example, a third element) between the element and another element.

The expression “configured to (or set to)” as used herein may be used interchangeably with “suitable for,” “having the capacity to,” “designed to,” “ adapted to,” “made to,” or “capable of” according to a context. The term “configured to (set to)” does not necessarily mean “specifically designed to” in a hardware level. Instead, the expression “apparatus configured to . . . ” may mean that the apparatus is “capable of . . . ” along with other devices or parts in a certain context. For example, “a processor configured to (set to) perform A, B, and C” may mean a dedicated processor (e.g., an embedded processor) for performing a corresponding operation, or a generic-purpose processor (e.g., a CPU or an application processor) capable of performing a corresponding operation by executing one or more software programs stored in a memory device.

The term “module” as used herein may be defined as, for example, a unit including one of hardware, software, and firmware or two or more combinations thereof. The term “module” may be interchangeably used with, for example, the terms “unit”, “logic”, “logical block”, “component”, or “circuit”, and the like. The “module” may be a minimum unit of an integrated component or a part thereof. The “module” may be a minimum unit performing one or more functions or a part thereof. The “module” may be mechanically or electronically implemented. For example, the “module” may include at least one of an application-specific integrated circuit (ASIC) chip, field-programmable gate arrays (FPGAs), or a programmable-logic device, which is well known or will be developed in the future, for performing certain operations.

The terms used in describing the various embodiments of the present disclosure are for the purpose of describing particular embodiments and are not intended to limit the present disclosure. As used herein, the singular forms are intended to include the plural forms as well, unless the context clearly indicates otherwise. All of the terms used herein including technical or scientific terms have the same meanings as those generally understood by an ordinary skilled person in the related art unless they are defined otherwise. The terms defined in a generally used dictionary should be interpreted as having the same or similar meanings as the contextual meanings of the relevant technology and should not be interpreted as having ideal or exaggerated meanings unless they are clearly defined herein. According to circumstances, even the terms defined in this disclosure should not be interpreted as excluding the embodiments of the present disclosure.

An electronic device according to the present disclosure may include at least one of a smartphone, a tablet personal computer (PC), a mobile phone, a video telephone, an electronic book reader, a desktop PC, a laptop PC, a netbook computer, a workstation, a server, a personal digital assistant (PDA), a portable multimedia player (PMP), a motion picture experts group (MPEG-1 or MPEG-2) audio layer 3 (MP3) player, a mobile medical device, a camera, or a wearable device. The wearable device may include at least one of an accessory-type device (e.g., a watch, a ring, a bracelet, an anklet, a necklace, glasses, a contact lens, a head-mounted device (HMD)), a textile- or clothing-integrated-type device (e.g., an electronic apparel), a body-attached-type device (e.g., a skin pad or a tattoo), or a bio-implantable-type device (e.g., an implantable circuit).

The electronic device may be a smart home appliance. The smart home appliance may include at least one of, for example, a television (TV), a digital video/versatile disc (DVD) player, an audio, a refrigerator, an air conditioner, a cleaner, an oven, a microwave oven, a washing machine, an air cleaner, a set-top box, a home automation control panel, a security control panel, a television (TV) box (e.g., Samsung HomeSync™, Apple TV™, or Google TV™), a game console (e.g., Xbox™ or PlayStation™), an electronic dictionary, an electronic key, a camcorder, or an electronic picture frame.

The electronic device may include at least one of various medical devices (e.g., various portable medical measurement devices (e.g., a blood glucose measuring device, a heart rate measuring device, a blood pressure measuring device, a body temperature measuring device, or the like), a magnetic resonance angiography (MRA), a magnetic resonance imaging (MRI), a computed tomography (CT), a scanner, an ultrasonic device, or the like), a navigation device, a global navigation satellite system (GNSS), an event data recorder (EDR), a flight data recorder (FDR), a vehicle infotainment device, electronic equipment for vessels (e.g., a navigation system, a gyrocompass, or the like), avionics, a security device, a head unit for a vehicle, an industrial or home robot, an automatic teller machine (ATM), a point of sales (POS) device of a store, or an Internet of Things (IoT) device (e.g., a light bulb, various sensors, an electric or gas meter, a sprinkler, a fire alarm, a thermostat, a streetlamp, a toaster, exercise equipment, a hot water tank, a heater, a boiler, or the like).

The electronic device may include at least one of a part of furniture or a building/structure, an electronic board, an electronic signature receiving device, a projector, or a measuring instrument (e.g., a water meter, an electricity meter, a gas meter, a wave meter, or the like). The electronic device may be one or more combinations of the above-mentioned devices. The electronic device may be a flexible device. The electronic device is not limited to the above-mentioned devices, and may include new electronic devices with the development of new technology.

Hereinafter, the electronic device according to various embodiments of the present disclosure will be described in more detail with reference to the accompanying drawings. The term “user” used herein may refer to a person who uses an electronic device or may refer to a device (e.g., an artificial intelligence electronic device) that uses an electronic device.

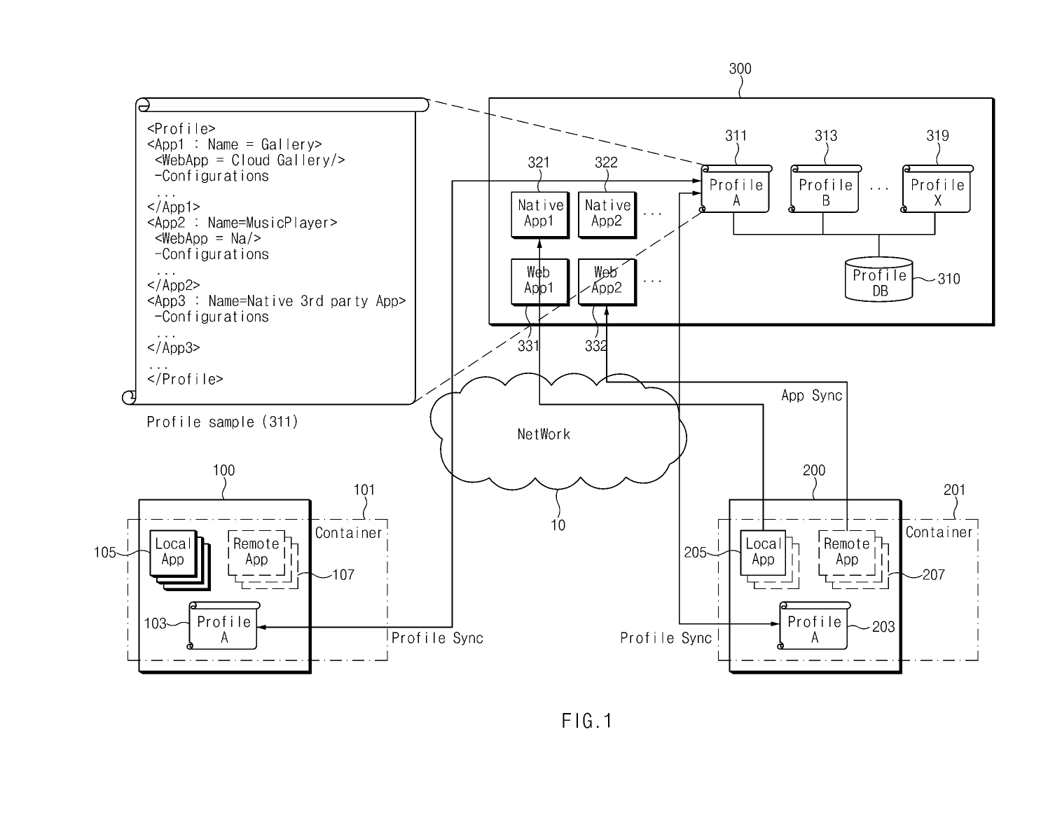

FIG. 1 is a diagram illustrating an environment for backing up and restoring configuration information (e.g., a container profile), according to an embodiment of the present disclosure.

A container, as used herein, may be defined as a storage space for separation and isolation of a portion of data stored in a terminal. Furthermore, the container may be used as a secure area, a work space, or a sandbox. If a container program (or a container launcher) is executed through a user interface, the container may be switched into a container mode (e.g., a secure operating mode (secure mode)), and thus functions (e.g., applications) included in the container may be provided.

One container may be completely isolated from an operating environment of another container or an operating environment of the outside of the container. An inquiry or sharing of a portion of data or a function (e.g., contacts, Internet application) between one container and another container may be exceptionally permitted. However, an inquiry/sharing of specific data (e.g., an enterprise document and an e-mail) or a function (e.g., a camera function) may be restricted.

A system for backup and restoration may include a first electronic device 100, a second electronic device 200, and a cloud server 300 that are connectable to each other through a network 10. In general, the first electronic device 100 and the second electronic device 200 may be terminals that are different from each other. The second electronic device 200 may be understood as being the first electronic device 100 itself or as being the initialized (e.g., factory reset) first electronic device 100.

The first electronic device 100 may include a container 101. The container 101 may include configuration information (e.g., a container profile 103 (e.g., a profile A)) that defines an environment for performing a function (hereinafter referred to as “function performance environment” or “operating environment”) of the container 101 (e.g., an environment configuration, an application (e.g., an application 105, an application 107, or the like) that is executable (usable) in the container 101). A “container profile” or simply a “profile” may be understood as referring to the configuration information.

Configuration information (e.g., the profile 103) may be synchronized with the server 300 through the network 10. The profile 103 of the container 101 uploaded to the server 300 may be stored as a profile 311 in a profile database 310. The profile 311 may be used to build a function performance environment, which corresponds to the container 101 of the first electronic device 100, in the second electronic device 200. If the profile A is synchronized among the first electronic device 100, the second electronic device 200, and the server 300, the profile 103, a profile 203, and the profile 311 may include the same information. In the case where the profile A is synchronized between the first electronic device 100 and the server 300 but is not synchronized between the server 300 and the second electronic device 200, the profile 103 may be the same as the profile 311, but the profile 103 may not be the same as the profile 203.

A profile may be generated/stored in the form of a structured document (e.g., an xml document). An example of the profile 311 is illustrated in FIG. 1. The profile 311 may include a list of applications, which are available (or installable) when the container 101 or a container 201 refers to the profile 311, and attributes and configuration information of each application. For example, the profile 311 may define a list of applications that include a gallery application, a music player application, and a third party application. Furthermore, the profile 311 may include information relating to whether each application is a web-based application (hereinafter referred to as “web app”).

The profile 311 may include a security policy, a hardware configuration, and a data synchronization level (e.g., a synchronization schedule, a synchronization scope, or the like) in addition to application information. For example, in the case where the container 101 is a container that supports a secure mode, the configuration information may include application information, a security policy, and a hardware configuration that are used in the secure mode.

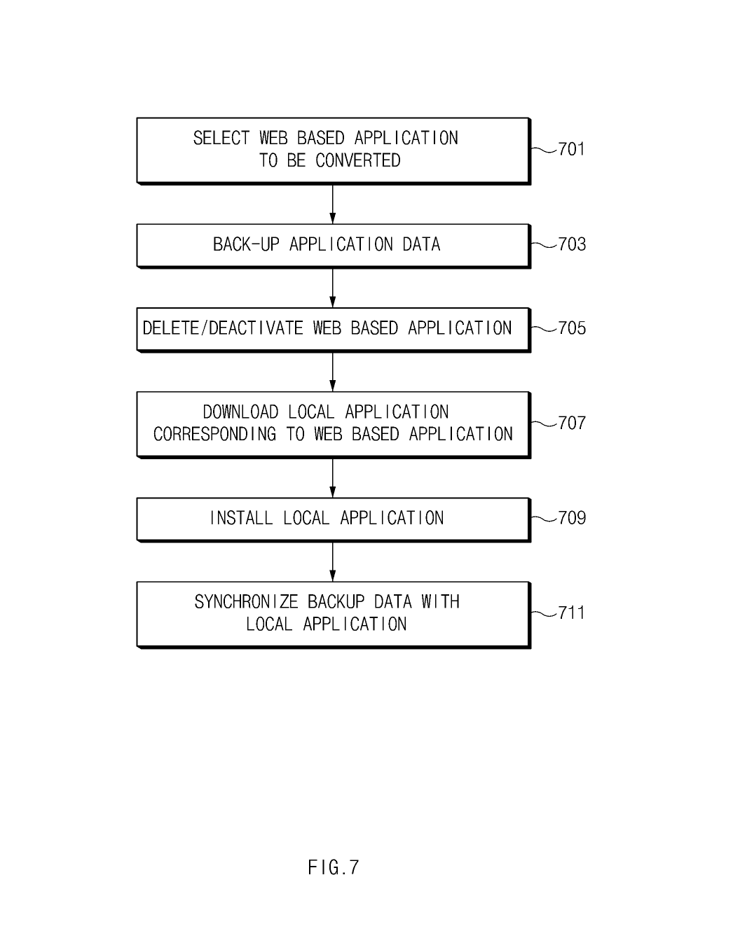

The web app, as used herein, is defined as an application that provides a function by accessing a web page or server without installing the application in a terminal. For example, each of the web app 107 of the first electronic device 100 and a web app 207 of the second electronic device 200 may correspond to the web app. In contrast, a non-web based application, for example, a local application, is defined as an application that is installed in and operates on a terminal. For example, each of the local application 105 and a local application 205 may correspond to a local application. The web app may be converted to the local application and vice versa, which will be described in more detail with reference to FIGS. 7 to 9.

The server 300 may include the profile database (DB) 310 that stores a plurality of profiles (e.g., a profile 313, . . . , and a profile 319) including the profile 311 corresponding to the backup profile 103. Furthermore, the server 300 may provide the local application (e.g., an application 321 or 322) and the web app (e.g., an application 331 or 332). The (cloud) server 300 may provide only the web app, and the local application may be provided from a separate server. In this disclosure, a server may be referred to as a cloud server or simply as a server without separate distinction.

In the case where a user of the first electronic device 100 wants to load the function performance environment of the container 101 at the second electronic device 200, the user may access the server 300 through the second electronic device 200 to download the profile A (i.e., the profile 311). The downloaded profile 311 may be used as the profile 203 in the second electronic device 200. The second electronic device 200 may only read the profile A 311 without downloading the profile A 311. The second electronic device 200 may load the profile 203 on the container 201 and may configure the local application 205 and the web app 207 defined in the profile 203. In the case where local applications defined in the profile 203 are applications previously installed in the second electronic device 200, the second electronic device 200 applies environment configuration information of the profile A to the installed applications. Before environment configuration information of the profile A is applied, a profile may not be applied to the application, or environment configuration information of another profile may be applied thereto. In the case where a new profile is applied, the second electronic device 200 may apply new environment configuration information to a previously installed application(s). In the case where an application previously installed in the second electronic device 200 is not a local application defined in the profile 203, the second electronic device 200 may access the cloud server 300 and download the local application (e.g., the application 321).

In the case of the web app defined in the profile 203, there may be no need to download a separate application or an application installation package. However, even in this case, user settings (e.g., automatic login, push notification setting, and the like) associated with the web app (e.g., the application 332) of the server 300 may be applied.

In a user interface of a container, a web app and a local application may be displayed differently according to different manners (e.g., different types of icons).

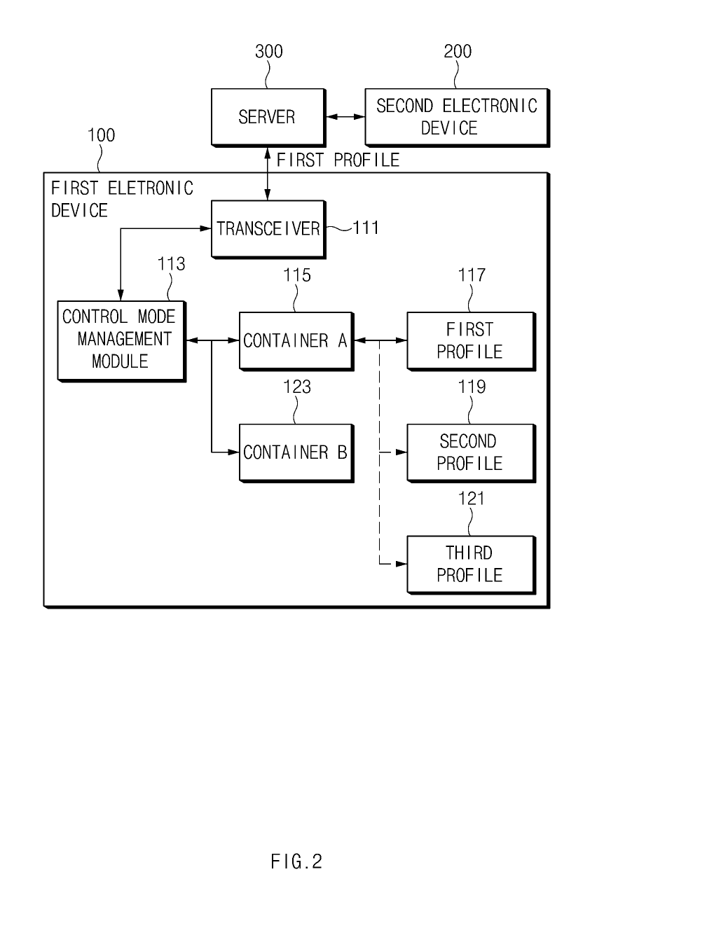

Below, a configuration of the first electronic device 100 for implementing an embodiment of the present disclosure will be described with reference to FIG. 2.

FIG. 2 is a diagram illustrating a terminal in which at least one control operating mode (control mode) is set by using configuration information, according to an embodiment of the present disclosure.

Referring to FIG. 2, the first electronic device 100 includes a plurality of containers. For example, the first electronic device 100 includes a container A 115 and a container B 123. The first electronic device 100 may selectively provide a plurality of control modes by using at least one container. The plurality of control modes may include a first operating mode (or a normal mode) that provides a function (e.g., an application) included in a normal storage space and a second operating mode (e.g., a secure mode and a business mode) that provides a function (e.g., an application) included in a storage space separated from the normal storage space. For example, the container A 115 may support the second mode (e.g., the secure mode and the business mode). In this case, the container B 123 may be a container that supports a third operating mode that is separated from the first operating mode and the second operating mode. The container A 115 may correspond to the above- described first mode (e.g., the normal mode or a non-secure mode), and the container B123 may correspond to the second mode (e.g., the secure mode).

The first electronic device 100 may include a control mode management module 113 that is able to configure a function performance environment in a container. The control mode management module 113 may be implemented with a software module and may be controlled by a control module (e.g., a processor) of the first electronic device 100. That is, the processor of the first electronic device 100 may implement the control mode management module 113. The control mode management module 113 may be referred to as a secure mode management module. The control mode management module 113 may support a function of generating, modifying, or deleting configuration information (e.g., a profile) with respect to each container.

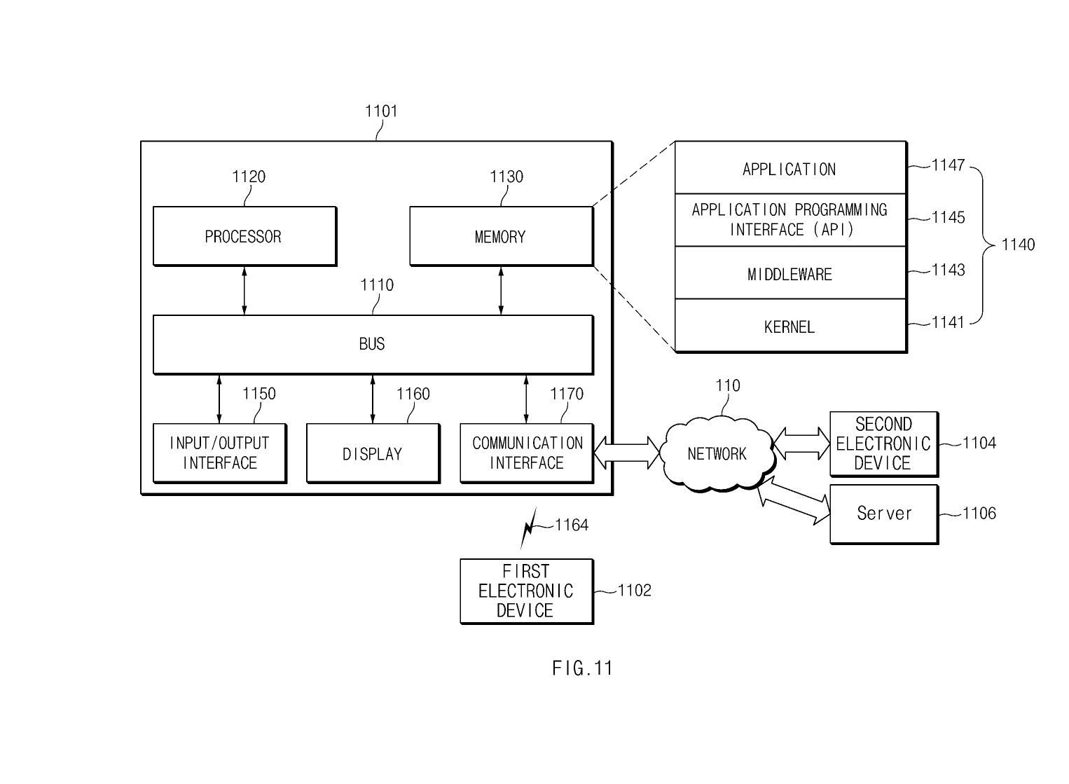

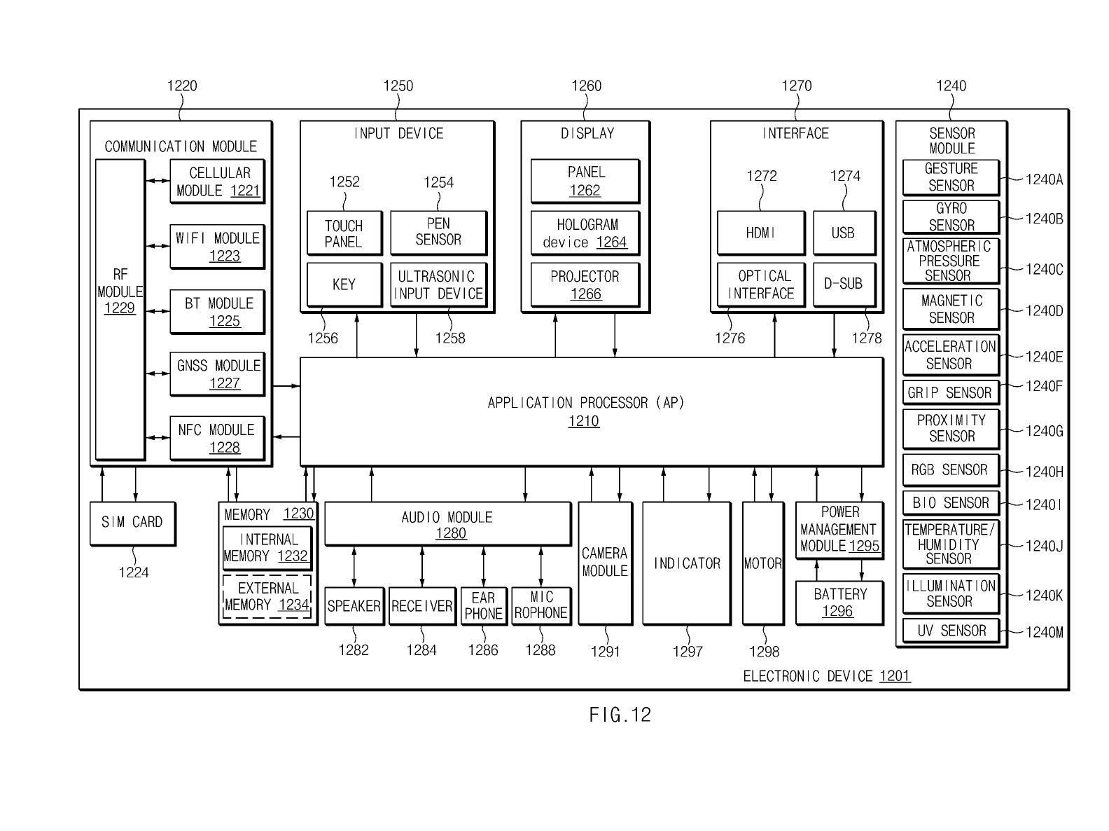

The first electronic device 100 may include a transceiver 111 for transmitting and receiving configuration information (e.g., a profile). The transceiver 111 may be a communication interface or a communication module. The transceiver 111 may be connected with an antenna and a communication processor for communication with a server. An element for communicating with the outside, such as the transceiver 111, will be described in more detail with reference to FIGS. 11 and 12.

The control mode management module 113 of the first electronic device 100 may transmit and receive a profile (e.g., a first profile 117) to and from the server 300 by using the transceiver 111. For example, the first electronic device 100 may send the first profile 117 to the server 300 to back up a current function performance environment of the container or may receive the first profile 117 from the server 300 to restore a previously used function performance environment of the container.

The second electronic device 200 may obtain the configuration information (e.g., the first profile 117) uploaded to the server 300 and may restore the function performance environment of the container A 115 of the first electronic device 100.

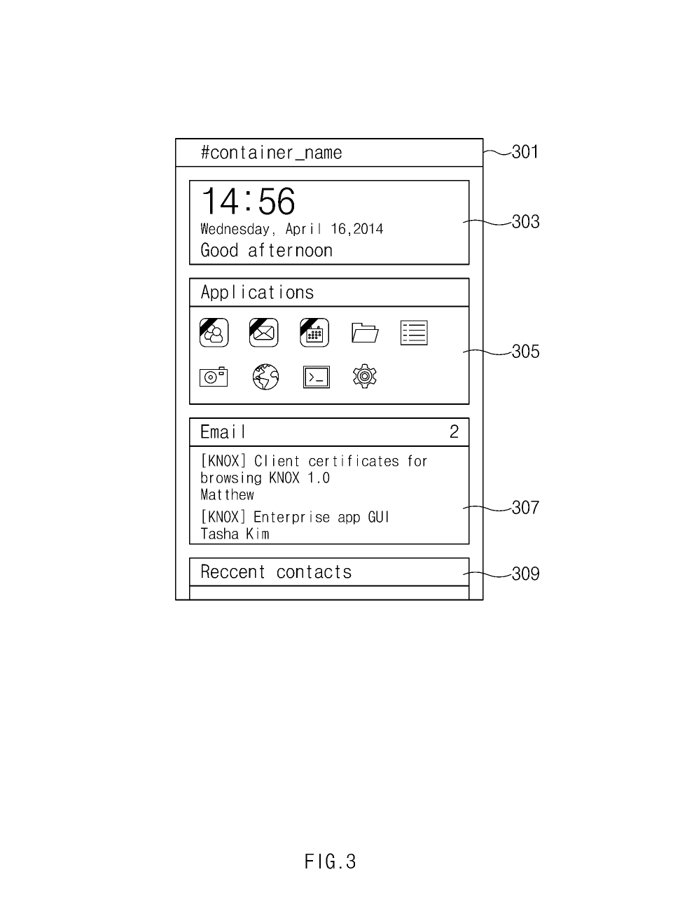

FIG. 3 is a diagram illustrating an execution screen of a control mode, according to an embodiment of the present disclosure.

Referring to FIG. 3, in the case where one container program is executed, a user interface of a control mode (e.g., the secure mode and the business mode) corresponding to the container program may be displayed. Configuration information (e.g., a container profile) for the control mode may include information about functions (e.g., a list of applications, application/user data, and a color theme or layout of a user interface) provided in the corresponding container space. In the case where a user provides an input (e.g., a touch gesture input) for changing a configuration with respect to at least one function through a user interface, the control mode management module 113 may receive the input to generate, modify, or delete at least a portion of the configuration information.

A user interface of a control mode (e.g., the secure mode and the business mode) may include a container name item 301 (i.e., #container_name). In a screen for setting or editing a profile, a name item of a container profile may be additionally or alternatively provided to the container name item 301.

A user interface of the secure mode, the business mode, and a KNOX™ (which provides security features that enable business and personal content to coexist on the same handset) container mode may provide a card view item 303. Basic contents, such as a date, time, and greeting, may be outputted on the card view item 303. The item may be differently displayed according to a color theme or layout of a container, a configuration of the container, and the like. A user may edit the card view item 303 by changing a theme or a template of the container.

A user interface of the secure mode, the business mode, and the KNOX container mode may provide a list 305 of applications. The application list 305 may include a web app and a local based application. The local based application may include a native application being basically (or essentially) installed in an electronic device and an additional application capable of being installed separately. Some of the additional applications may be provided as web apps or may be converted to web apps. A web app and a local based application may be respectively displayed in the application list 305 in manners (e.g., a diagonal stripe is displayed on a left top area of an application icon) that are distinguishable from each other.

A user interface of the secure mode, the business mode, and the KNOX container mode may provide information about some applications, such as an e-mail 307 and recent contacts 309, or some functions. Data used in an application, data (e.g., ID, password, and the like) associated with a user account, or additional user data (e.g., a document, an image, a video, and the like) may be utilized to configure a user interface. In the case where a user backs up the corresponding configuration information (e.g., a container profile) after excluding the e-mail item 307 from the user interface of FIG. 3, the user may not confirm the e-mail item 307 if the container is configured on another electronic device based on the backup configuration information (e.g., a profile). In this case, it may be possible to generate the e-mail item 307 if the user updates a user configuration in the corresponding electronic device.

Information or data included in configuration information (e.g., a container profile) may satisfy the following conditions. First, information about a value/configuration that is able to be set by a user may be included in the configuration information. For example, a notification type or a background image may be capable of being set by a user and may be included in the configuration information. Also, since configuration information is able to be restored in another device after backed up in one device, the configuration value of one device, that is, data (e.g., portable data), which is applicable to another device in the same way, may be included in configuration information. Additionally, information (data), which is applicable based on system resources, such as a memory capacity, specifications of a processor, and a communication environment (e.g., a kind, a speed, and a bandwidth of a network) of an electronic device, to which configuration information is applied, may also be included in the configuration information. For example, a function (e.g., automatic update) that is operable only in wireless fidelity (Wi-Fi) environment may be included in the configuration information.

Static data (e.g., a photo, a video, a document, a calendar, contacts, and the like) may be defined in the configuration information so as to be adaptively configured according to a processing environment of an electronic device. For example, the static data may be excluded from the configuration information. Since an electronic device is able to use a communication resource for backing up and restoring of a profile, a data capacity may affect a time and a cost (communication charge) used for backup and restoration. Therefore, only data that satisfies a specific capacity limit may be included in the profile. Furthermore, for example, the static data may be set differently according to a data capacity. An image file of which a file size is less than 5 MB may be included in a profile and then backed-up. However, it may be defined in configuration information that an image file of which a file size is greater than or equal to 5 MB is excluded from a backup target or is converted into low quality or another format and then backed-up.

Even though a portion of data/information included in a container profile is changed, the changed data/information may be data/information (e.g., delta updateable data) that is applicable to a container of another device. Furthermore, even though specific data does not exist in a device or container that is changed before and after restoration, data/information that does not interfere with an operation may be included in the container profile. For example, data, which is able to be stored in the form of database having a default value, may be included in the profile. In the case where a specific data value (e.g., a background image or Wi-Fi configuration information) is absent in the container configured through the profile, an electronic device may configure a function performance environment of the container by using the default value (e.g., a native image, a basic Wi-Fi configuration (e.g., automatic connection to known Wi-Fi or no connection) and the like).

Configuration information (e.g., a container profile) may be synchronized according to a network status. For example, if specific data is changed after a function performance environment is loaded by using an initial (native) profile, the synchronization of the changed data (e.g., delta updateable data) may be performed. For example, if one application of the application list 305 is deleted from a container, an electronic device may determine a current network status and may upload the changed data/information to the server 300 based on the determined result (e.g., Wi-Fi connection status). The server 300 may synchronize the profile by applying the obtained changed data/information to the corresponding profile. Furthermore, the synchronization may be manually performed by a user, may be periodically performed, or may be performed whenever there is the changed data/information.

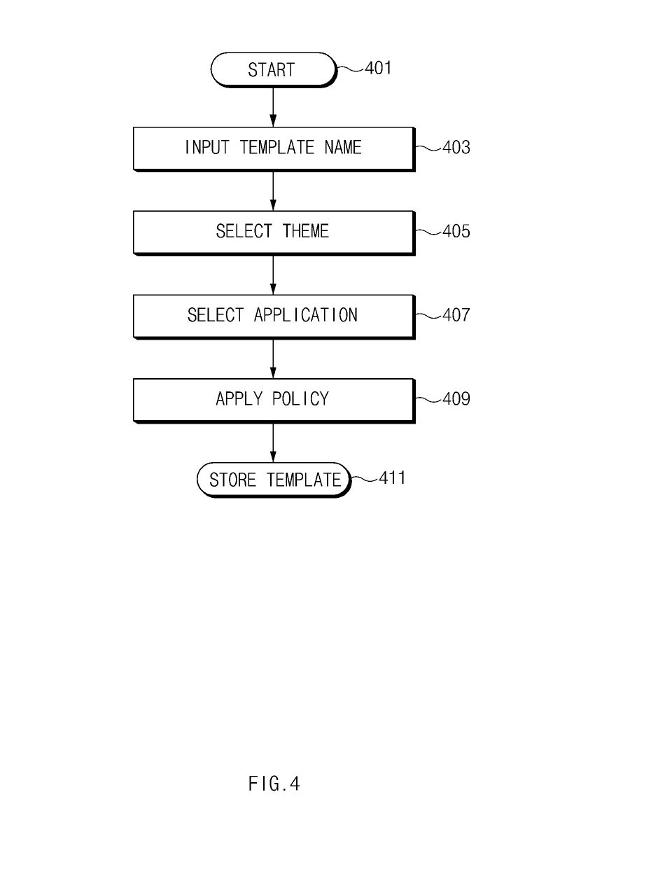

FIG. 4 is a flowchart of a method for configuring a configuration information template, according to an embodiment of the present disclosure. An embodiment of FIG. 4 may be performed at a configuration information template authoring device or server by an IT admin of an enterprise or a group. Hereinafter, the configuration information template authoring device is referred simply to as “authoring device”. The authoring device may correspond to the server 300 or may correspond to a separate server managed by an enterprise. A configuration of the authoring device may correspond to the configuration of the first electronic device 100 described in FIG. 11.

In operation 401, a process may start as a template authoring tool is executed at the authoring device. The template authoring tool may be an application. In operation 403, a template name may be defined, and in operation 405, a theme that is to be applied to a container may be selected. For example, a background image, a font, a ring tone, and the like may be set.

In operation 407, an application included in a function performance environment of the container may be selected. The IT admin may select an application suitable for the container. For example, in the case of a container for enterprise, an e-mail account, a messenger application, a database, a human resource application, and the like of the enterprise may be selected. In addition, applications of a phone, a text, a web browser, and the like that are usable in common may be selected. At least a portion of the application selected during operation 407 may be uploaded into a server (e.g., the server 300) or some of the applications registered in the server in advance may be selected. In the case where a user selects a template generated/stored according to the method of FIG. 4 in a user device, the application selected in operation 407 of FIG. 4 may be downloaded or may be provided in a downloadable form.

In operation 409, a policy may be applied to the container. For example, the IT admin may determine a security policy and may apply the determined security policy to a template of the container. A specific function may be activated or deactivated based on the policy applied in operation 409. For example, in the case where a security policy about the photograph prohibition is applied, an application associated with a camera may not be installed or may not be executed even if installed, in the corresponding container. Besides, various mobile device management (MDM) policies may be selectively applied to the template.

In operation 411, the template may be stored. The template may be stored in the form of a profile corresponding to a specific container. For example, an operable secure template may be stored in the form of a profile in a secure container (or a business container). The corresponding profile may be loaded in the secure container, but may not be loaded in another container. In this regard, configuration information (e.g., a profile) that is operable or loadable in only the specific container may be provided. For example, an electronic device or a server (e.g., the IT admin) may determine whether it is valid to apply the profile, based on a specific certificate of the electronic device or whether a requirement associated with a user account is satisfied. In the case where there is no certificate in the electronic device or in the case where a user account does not meet the specific condition, a portion of configuration information may be determined as being invalid, and thus the electronic device may fail to operate or load.

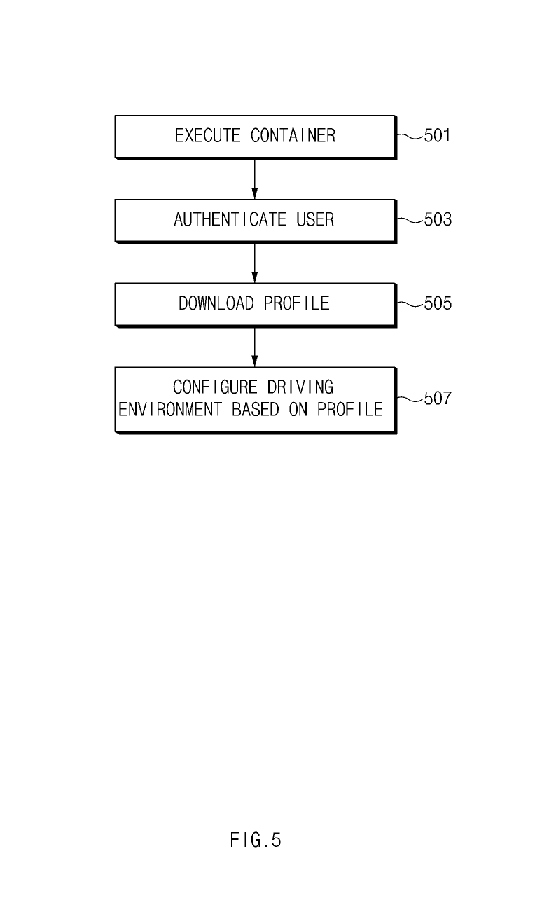

FIG. 5 is a flowchart of a method for applying configuration information, according to an embodiment of the present disclosure. A method of FIG. 5 may be applied in the case where a container is executed for the first time. However, according to the configuration, even if a container is not executed for the first time, a menu (screen) that makes it possible to enter the process of FIG. 5 may be provided instead of automatically loading the previously configured profile.

In operation 501, a user terminal (e.g., the first electronic device 100 or the second electronic device 200) may execute a container program. For example, one of a plurality of containers (e.g., a container A and a container B) stored in the user terminal may be executed. The executed container may request user authentication, and if user information (e.g., account information) is obtained in operation 503, authentication may be performed with respect to whether the user is a right user.

Operation 503 may be performed together with operation 501, or operation 501 may be performed after operation 503 is performed. For example, the container program may be executed after the user authentication is completed, or the user authentication may correspond to a portion of the process of executing the container program.

In operation 505, the user terminal may download a profile that is to be applied to the executed container. For example, if the container is executed in the first electronic device 100, the server 300 may provide a user of the first electronic device 100 with a suitable profile based on the user authentication information obtained in operation 503. In the case where a plurality of profiles are provided, the first electronic device 100 may download the selected profile if one profile is selected.

In operation 507, the user terminal may configure a function performance environment of the container based on the downloaded profile. For example, the user terminal may collect environment settings, background images, an application list, user settings, user data, and the like from the profile and may configure a screen and an application to be provided, a function, a restricted function or application, or the like, based on the collected information.

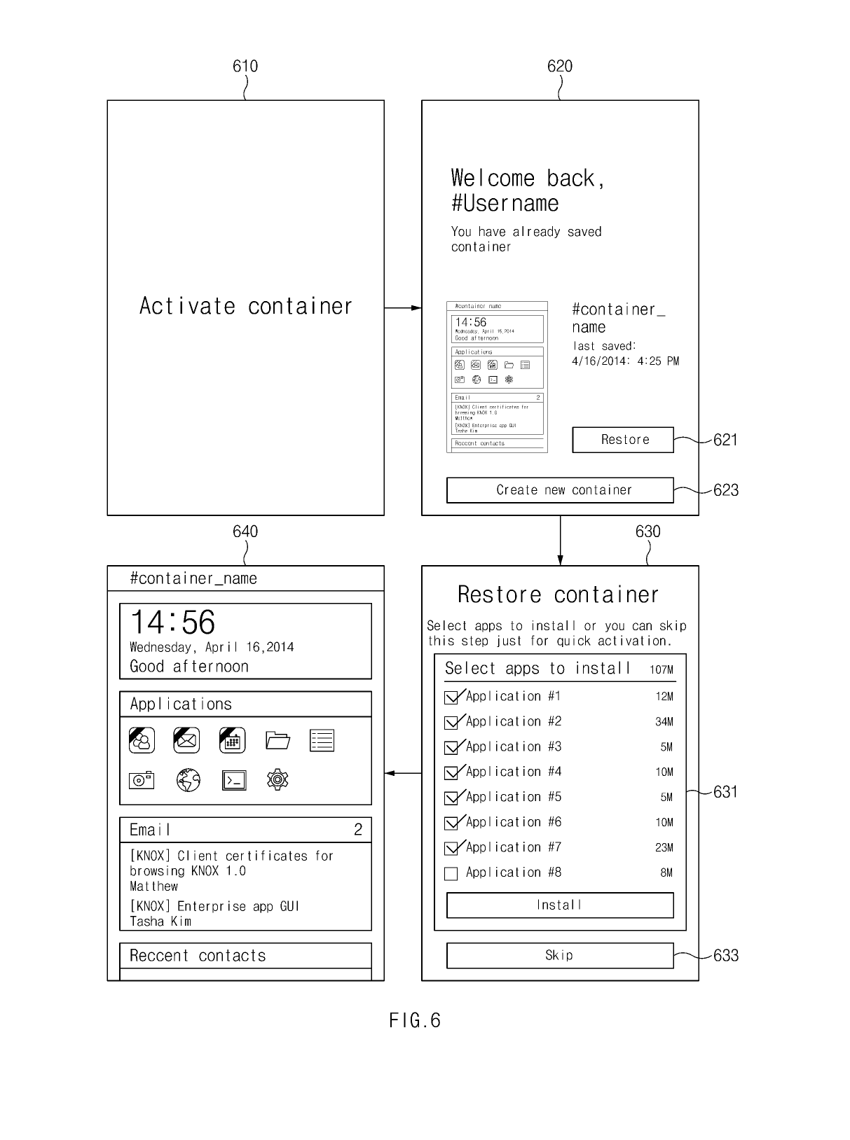

FIG. 6 is a diagram of screens in which configuration information is applied, according to an embodiment of the present disclosure.

If a function performance environment of a container starts to operate in the first electronic device 100 or the second electronic device 200, in particular, in the case where the environment starts to operate for the first time, a screen 610 is provided.

Afterwards, a screen 620 for determining the function performance environment of the container is provided. In the case where the container is executed before or in the case where there is configuration information that is based on the container and user information, the screen 620 may provide information about the container to be executed (restored) and an execution (restore) menu 621. Furthermore, the screen 620 may provide a creation menu 623 for creating a new container (and configuration information). If the creation menu 623 is selected, an application to be driven in the newly created container and an application and data to be restored later may be additionally selected.

If the menu 621 is selected, a screen 630 for selecting an application to be installed in the container may be provided. The screen 630 may include an application selection screen 631 and a skip menu 633. The selection screen 631 may provide a list of all applications defined in a profile. Furthermore, the selection screen 631 may provide a list of local based applications that need to be installed in an electronic device. The selection screen 631 may display a list of applications together with the capacity of each application. In the case where the selection screen 631 additionally displays a web app or a native application installed in the electronic device in addition to a local application, the capacities of the web app and native application may not be displayed, or “0” or the capacity corresponding to an application/data may be displayed. An application may be displayed according to whether an application type is web-based or local-based. In the case where it is determined that the resources (e.g., a memory capacity, processor specifications, a processing speed, hardware specifications, and a communication quality) of an electronic device is not suitable for driving an application (e.g., in the case of a shortage of a memory capacity, a low-end processor, and the like), an indication that suggests conversion of local applications into web apps may be displayed. When a user utilizes an electronic device, which has low-end hardware resources, in conjunction with any other electronic device that has high-end hardware resources, the electronic device may display an indication that suggests installation of some local applications on the other electronic device and operations of the two electronic devices in conjunction with each other. If some or all of applications are selected, the selected applications may be installed in the container. For example, the first electronic device 100 may access the server 300 to download the selected applications. If an application is completely installed and if the container is activated, a screen 640 may be provided.

FIG. 7 is a flowchart of a method for converting a web app to a local application, according to an embodiment of the present disclosure.

In a process of backing up and restoring configuration information (e.g., a profile) of a container, as the number of applications to be backed up or restored increases, a sufficient amount of time may be necessary for the backup and restoration process. In the case where some applications are applications capable of operating through an access to a web (server), not applications installed and operating on a user terminal, the capacity that is needed to back up and restore the applications may be markedly reduced. For example, in the case of a web app, a package (*.apk file) that is needed to install an application may be excluded from backup and restoration targets.

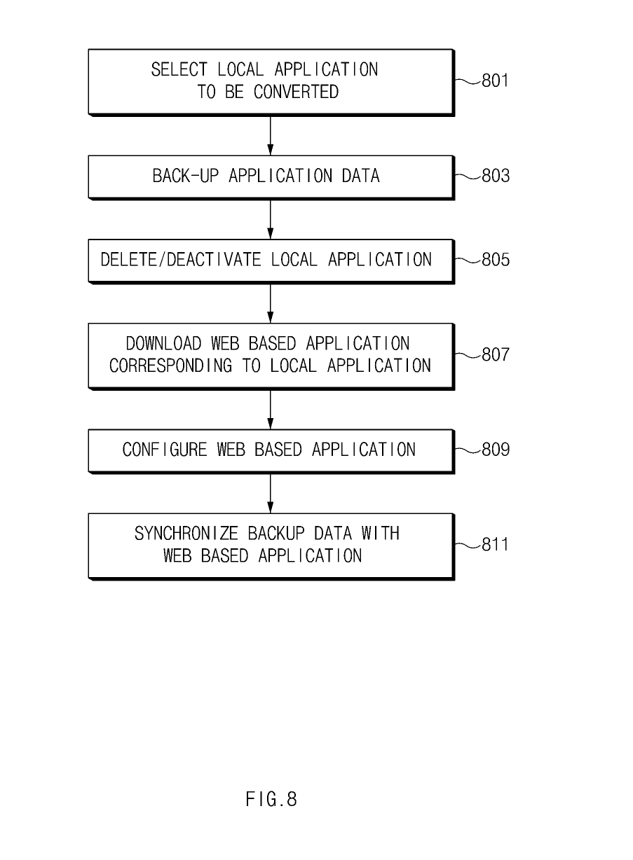

A user of the first electronic device 100 may back up configuration information (e.g., a profile) and may restore a function performance environment of a container based on the backup profile at the second electronic device 200. In the case where a user of the second electronic device 200 is different from a user of the first electronic device 100, the user of the first electronic device 100 may backup/restore applications as web apps as many as possible, thereby making it possible to easily use the second electronic device 200 temporarily. However, in the case where the user of the second electronic device 200 is the same as the user of the first electronic device 100 (e.g., in the case of exchanging or adding an electronic device that a user utilizes) or in the case where the configuration information backed up to the first electronic device 100 is again restored on the first electronic device 100 (e.g., in the case where a user initializes the first electronic device 100), a web app may be converted into a local based application to use the application regardless of the use of all functions of the application or whether a network is available. In the case where there is a change of resources of the first electronic device 100 (e.g., a memory capacity, processor specifications, a processing speed, hardware specifications, and a communication quality), for example, in the case where it is detected that a capacity of an available memory increases or that a communication speed becomes slow, an indication that suggests installation of some of web apps as local based applications may be displayed. FIG. 7 illustrates an example of a method of the above-described conversion procedure. In contrast, FIG. 8 illustrates an example of a method in which a local based application is converted into a web app.

In operation 701, a web app to be converted to a local application may be selected. Before performing operation 701, a user terminal may execute a conversion program or may connect to a conversion server.

In operation 703, the user terminal may back up data of the selected web app. For example, configuration information, user data, and application data associated with the web app may be backed up. The user terminal may separately store data to be backed up in a storage space (e.g., a memory) of the user terminal or may upload the data to a server (e.g., the server 300).

If the data is completely backed up, in operation 705, the user terminal may delete or deactivate the web app. Confusion that is generated due to existence of the same applications of a web based version and a local based version may be prevented by deleting or deactivating the web app. Moreover, a synchronization error of user data, which is generated by executing the substantially same application in different versions, may be also prevented. Furthermore, since the web app is practically executed on the web in the case of the web app, to deactivate the web app in operation 705 may include deleting information, an icon, a link, and the like that are needed to execute the web app in a container or changing the link to a web app so as to be linked to a local based application.

In operation 707, the user terminal may download a local based application corresponding to the deleted web app from the server. In the case where a local based application is in an inactive state, a user terminal may activate the local based application, which is in an inactive state, instead of downloading the local based application from a server.

In operation 709, the user terminal may install the downloaded local based application in the container. If the local based application is activated in operation 707, operation 709 may be omitted.

In operation 711, the user terminal may synchronize data of the web app backed up with the local based application. For example, the user terminal may apply the backup data, which is downloaded from the server or loaded from the memory area, to the local based application. A web app may be converted into a local based application through the above-described process.

FIG. 8 is a flowchart of a method for converting a local application to a web app, according to an embodiment of the present disclosure. A portion of a description of the method of FIG. 8, which is similar to or corresponds to the method of FIG. 7, may be omitted.

In the case where there is a change of resources of the first electronic device 100 (e.g., a memory capacity, processor specifications, a processing speed, hardware specifications, and a communication quality), for example, in the case where it is detected that a capacity of an available memory decreases or that a communication speed increases, an indication that suggests installation of some of local based applications as web apps may be displayed. Alternatively, in the case where another electronic device of the user, which has high-end resources and interworks with the first electronic device 100, is detected, an indication that suggests installation of some of local based applications to be operated in conjunction with another electronic device may be displayed.

In operation 801, a local application to be converted to a web app may be selected. In operation 801, if a web app corresponding to a local based application does not exist or if it is not supported to convert a local based application to a web app, an error message may be outputted.

In operation 803, a user terminal may back up data of the selected local based application. If the data is completely backed up, in operation 805, the user terminal may delete or deactivate the local based application.

In operation 807, the user terminal may download the web app corresponding to the local based application from a server or may activate the web app that is in the inactive state. Unlike operation 707, in operation 807, the user terminal may download data/information, which makes it possible to connect to a web that provides a function of the web app, such as connection information (e.g., uniform resource locator (URL), link, and the like) with the web app, a shortcut, an icon image, and a configuration file.

In operation 809, the user terminal may configure the web app in the container. If the web app is activated in operation 807, operation 809 may be omitted. In operation 811, the user terminal may synchronize the backup data with the web app.

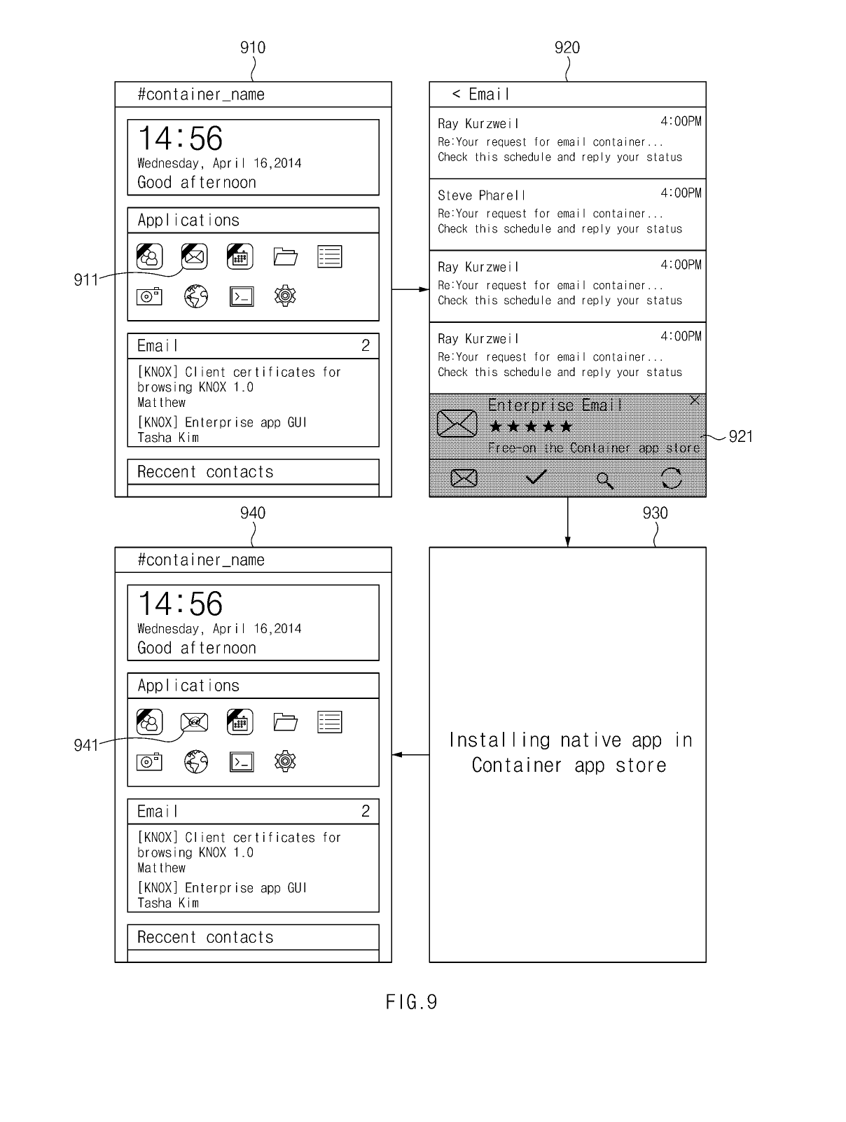

FIG. 9 is a diagram of screens for converting a web app to a local based application, according to an embodiment of the present disclosure.

For example, a user interface of a control mode, in which a container is executed, such as a screen 910, may be provided. In the screen 910, an e-mail application may be classified as a web app item 911 and then displayed. If the e-mail application 911 is selected and executed by a user action, as shown in a screen 920, the web server corresponding to the corresponding application may provide an e-mail list based on user account information.

In the screen 920, an item 921 for converting a web app to a local based application may be provided. In this case, a conversion interface may provide a user with additional information of an application to be converted. For example, the additional information may include evaluation information (e.g., a star rating, a review, and the like) of an application, price information (e.g., paid, free, in-app payment, or the like), an application name, an application icon, and the like.

A conversion screen 930 may be provided if the conversion starts according to a user action. The above-mentioned process of FIG. 7 may be performed while the conversion screen 930 is provided. If the conversion is completed, a function performance environment of a container, such as a screen 940, may be provided. In the screen 940, an e-mail application may be provided with a local based application item 941.

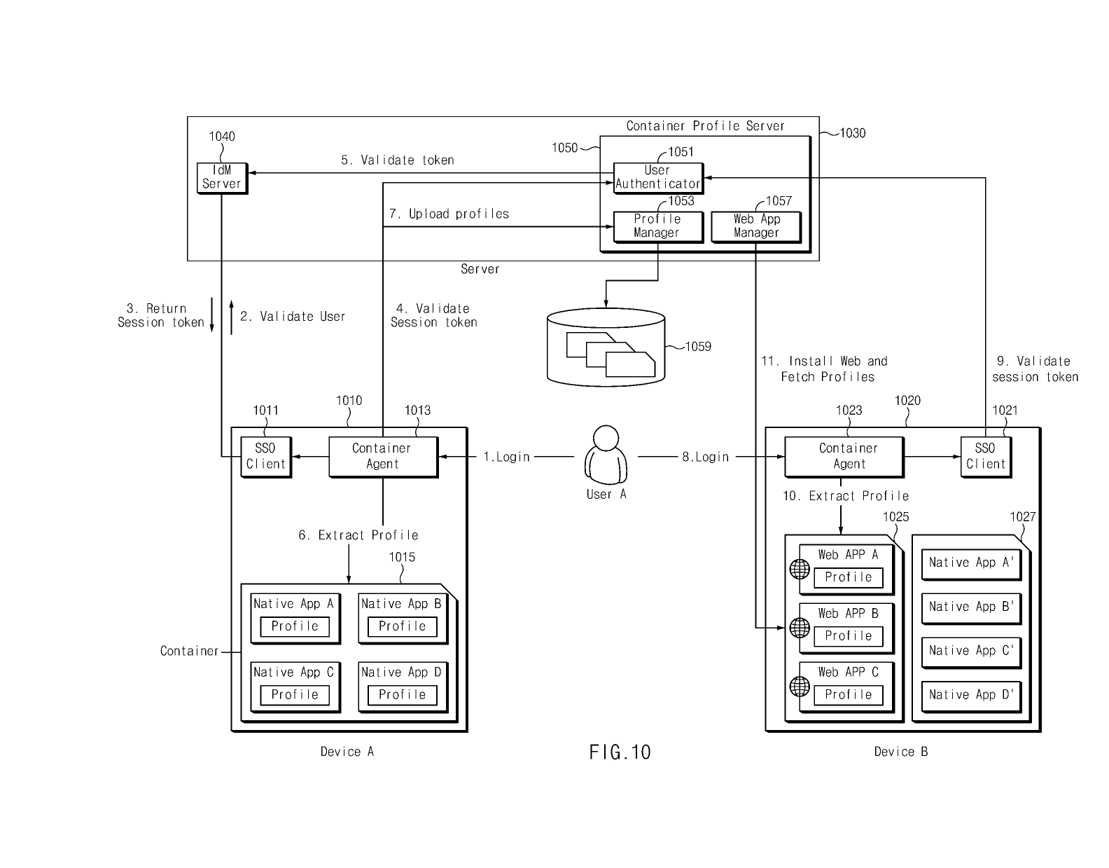

FIG. 10 is a diagram illustrating configuration information being synchronized based on an account at different electronic devices, according to an embodiment of the present disclosure.

Before the synchronization of FIG. 10 is performed, an account of a user (e.g., a user A) may be registered in a server 1030 (e.g., the server 300 of FIG. 1). A user may directly register the user account, or for example, an IT admin of an enterprise may register the user account.

The log in into an electronic device 1010 may be done with the user account. For example, a container may be executed at the electronic device 1010, and if user account information is inputted, a container agent 1013 may configure the container based on the user account.

For example, the container agent 1013 may request an identity management (IdM) server 1040 to authenticate the inputted user account information (or authentication information) through a single-sign-on (SSO) client 1011. If the IdM server 1040 receives the authentication request, the IdM server 1040 may return a session token to the SSO client 1011 of the electronic device 1010. The container agent 1013 may request a container profile server 1050 to authenticate the obtained session token. For example, a user authenticator 1051 of the server 1050 may authenticate whether the session token is for the right user. The container profile server 1050 may be a server that is independent of the IdM server 1040. However, the container profile server 1050 and the IdM server 1040 may be understood as one server 1030.

If the token is authenticated, the container agent 1013 may extract a profile of a container 1015 and upload the corresponding profile to the server 1030. For example, if a profile of a specific container is uploaded to the server 1050, a profile manager 1053 of the server 1050 may store the uploaded profile in a container profile repository 1059. This process may be understood as the above-mentioned process of backing up a profile.

The same user (e.g., the user A) may log in into an electronic device 1020 that is a terminal of another user (e.g., a user B). As with a user authentication process at the electronic device 1010, a container agent 1023 may obtain user account information (or authentication information) and may perform a process of authenticating the session token with respect to the obtained user account. In this case, another user who is not an original user of the electronic device 1020 may log in into the electronic device 1020, and the container agent 1023 may generate a new container 1025. The container 1025 may be operated while it is separated from a container 1027 of the original user (e.g., the user B) of the electronic device 1020.

The container agent 1023 may obtain the backup profile from the server 1050. On the basis of the obtained profile, the container agent 1023 may configure the application and apply a variety of configuration information. For example, a local based application of an application list included in a profile may be downloaded from the server 1050 or a server that provides another application, and a web app may request the server 1050 to perform synchronization based on user information of the profile and/or configuration information of the profile. A web application manager 1057 of the server 1050 may configure a web app of the container 1023 based on the profile and the request from the electronic device 1020.

FIG. 11 is a diagram illustrating an electronic device in a network environment, according to an embodiment of the present disclosure.

The electronic device 1101 includes a bus 1110, a processor 1120, a memory 1130, an input/output interface 1150, a display 1160, and a communication interface 1170. At least one of the foregoing elements may be omitted or another element may be added to the electronic device 1101.

The bus 1110 may include a circuit for connecting the above-mentioned elements 1110 to 1170 to each other and transferring communications (e.g., control messages and/or data) among the above-mentioned elements.

The processor 1120 may include at least one of a central processing unit (CPU), an application processor (AP), or a communication processor (CP). The processor 1120 may perform data processing or an operation related to communication and/or control of at least one of the other elements of the electronic device 1101. The processor 1120 may perform functions disclosed herein or may implement modules (e.g., software modules or engines) for performing the functions. Functions performed by a processor described herein may be understood functions performed by a module, or vice versa.

The memory 1130 may include a volatile memory and/or a nonvolatile memory. The memory 1130 may store instructions or data related to at least one of the other elements of the electronic device 1101. The memory 1130 may store software and/or a program 1140. The program 1140 may include, for example, a kernel 1141, a middleware 1143, an application programming interface (API) 1145, and/or an application program (or an application) 1147. At least a portion of the kernel 1141, the middleware 1143, or the API 1145 may be referred to as an operating system (OS).

The electronic device 1101 may isolate and/or manage containers in different areas of the memory 1130, based on the purpose or type (e.g., secure type or normal type) of the containers. For example, the memory 1130 may comprise a first memory area (e.g., a normal storage area) and a second memory area (e.g., a secure storage area). For example, the memory 1130 may store data related to secure container into the secure storage area which has an address logically different from the normal storage area. In another example, the electronic device 1101 may comprise a normal memory device and a secure memory device physically different each other.

The kernel 1141 may control or manage system resources (e.g., the bus 1110, the processor 1120, the memory 1130, or the like) used to perform operations or functions of other programs (e.g., the middleware 1143, the API 1145, or the application program 1147). Furthermore, the kernel 1141 may provide an interface for allowing the middleware 1143, the API 1145, or the application program 1147 to access individual elements of the electronic device 1101 in order to control or manage the system resources.

The middleware 1143 may serve as an intermediary so that the API 1145 or the application program 1147 communicates and exchanges data with the kernel 1141.

Furthermore, the middleware 1143 may handle one or more task requests received from the application program 1147 according to a priority order. For example, the middleware 1143 may assign at least one application program 1147 a priority for using the system resources (e.g., the bus 1110, the processor 1120, the memory 1130, or the like) of the electronic device 1101. For example, the middleware 1143 may handle the one or more task requests according to the priority assigned to the at least one application, thereby performing scheduling or load balancing with respect to the one or more task requests.

The API 1145, which is an interface for allowing the application 1147 to control a function provided by the kernel 1141 or the middleware 1143, may include, for example, at least one interface or function (e.g., instructions) for file control, window control, image processing, character control, or the like.

Each application is installed in each of the separate containers, and each of the separate containers may be managed individually. For example, certain applications may be installed to containers different from each other, and the certain applications may be operated using different settings or different user accounts on each container.

The input/output interface 1150 may serve to transfer an instruction or data input from a user or another external device to other elements of the electronic device 1101. Furthermore, the input/output interface 1150 may output instructions or data received from other elements of the electronic device 1101 to the user or another external device.

The display 1160 may include, for example, a liquid crystal display (LCD), a light-emitting diode (LED) display, an organic light-emitting diode (OLED) display, a microelectromechanical systems (MEMS) display, or an electronic paper display. The display 1160 may present various content (e.g., a text, an image, a video, an icon, a symbol, or the like) to the user. The display 1160 may include a touch screen, and may receive a touch, gesture, proximity or hovering input from an electronic pen or a part of a body of the user.

The communication interface 1170 may set communications between the electronic device 1101 and an external device (e.g., a first external electronic device 1102, a second external electronic device 1104, or a server 1106). For example, the communication interface 1170 may be connected to a network 1162 via wireless communications or wired communications so as to communicate with the second external electronic device 1104 or the server 1106.

The wireless communications may employ at least one of cellular communication protocols such as long-term evolution (LTE), LTE-advance (LTE-A), code division multiple access (CDMA), wideband CDMA (WCDMA), universal mobile telecommunications system (UMTS), wireless broadband (WiBro), or global system for mobile communications (GSM). The wireless communications may include, for example, a short-range communications 1164. The short-range communications may include at least one of Wi-Fi, Bluetooth, near field communication (NFC), or GNSS. The GNSS may include, for example, at least one of global positioning system (GPS), global navigation satellite system (GLONASS), BeiDou navigation satellite system (BeiDou), or Galileo, the European global satellite-based navigation system according to a use area or a bandwidth. Hereinafter, the term “GPS” and the term “GNSS” may be interchangeably used. The wired communications may include at least one of universal serial bus (USB), high definition multimedia interface (HDMI), recommended standard 832 (RS-232), plain old telephone service (POTS), or the like. The network 1162 may include at least one of telecommunications networks, for example, a computer network (e.g., local area network (LAN) or wide area network (WAN)), the Internet, or a telephone network.

The types of the first external electronic device 1102 and the second external electronic device 1104 may be the same as or different from the type of the electronic device 1101. The server 1106 may include a group of one or more servers. A portion or all of operations performed in the electronic device 1101 may be performed in one or more of the first electronic device 1102, the second external electronic device 1104, or the server 1106. When the electronic device 1101 performs a certain function or service automatically or in response to a request, the electronic device 1101 may request at least a portion of functions related to the function or service from the first electronic device 1102, the second external electronic device 1104, or the server 1106 instead of or in addition to performing the function or service for itself. The first electronic device 1102, the second external electronic device 1104, or the server 1106 may perform the requested function or additional function, and may transfer a result of the performance to the electronic device 1101. The electronic device 1101 may use a received result itself or additionally process the received result to provide the requested function or service. To this end, for example, a cloud computing technology, a distributed computing technology, or a client-server computing technology may be used.

FIG. 12 is a diagram illustrating an electronic device, according to an embodiment of the present disclosure.

Referring to FIG. 12, an electronic device 1201 may include, for example, a part or the entirety of the electronic device 1101 illustrated in FIG. 11. The electronic device 1201 includes at least one processor (e.g., AP) 1210, a communication module 1220, a subscriber identification module (SIM) 1224, a memory 1230, a sensor module 1240, an input device 1250, a display 1260, an interface 1270, an audio module 1280, a camera module 1291, a power management module 1295, a battery 1296, an indicator 1297, and a motor 1298.

The processor 1210 may run an operating system or an application program so as to control a plurality of hardware or software elements connected to the processor 1210, and may process various data and perform operations. The processor 1210 may be implemented with, for example, a system on chip (SoC). The processor 1210 may further include a graphic processing unit (GPU) and/or an image signal processor. The processor 1210 may include at least a portion (e.g., a cellular module 1221) of the elements illustrated in FIG. 12. The processor 1210 may load, on a volatile memory, an instruction or data received from at least one of other elements (e.g., a nonvolatile memory) to process the instruction or data, and may store various data in a nonvolatile memory.

The communication module 1220 may have a configuration that is the same as or similar to that of the communication interface 1170 of FIG. 11. The communication module 1220 may include, for example, a cellular module 1221 (e.g., the modem 1330), a Wi-Fi module 1223, a Bluetooth module 1225, a GNSS module 1227 (e.g., a GPS module, a GLONASS module, a BeiDou module, or a Galileo module), an NFC module 1228, and a radio frequency (RF) module 1229.

The cellular module 1221 may provide, for example, a voice call service, a video call service, a text message service, or an Internet service through a communication network. The cellular module 1221 may identify and authenticate the electronic device 1201 in the communication network using the SIM card 1224. The cellular module 1221 may perform at least a part of functions that may be provided by the processor 1210. The cellular module 1221 may include a communication processor (CP).

Each of the Wi-Fi module 1223, the Bluetooth module 1225, the GNSS module 1227 and the NFC module 1228 may include, for example, a processor for processing data transmitted/received through the modules. At least a part (e.g., two or more) of the cellular module 1221, the Wi-Fi module 1223, the Bluetooth module 1225, the GNSS module 1227, and the NFC module 1228 may be included in a single integrated chip (IC) or IC package.

The RF module 1229 may transmit/receive, for example, communication signals (e.g., RF signals). The RF module 1229 may include, for example, a transceiver, a power amp module (PAM), a frequency filter, a low noise amplifier (LNA), an antenna, or the like. At least one of the cellular module 1221, the Wi-Fi module 1223, the Bluetooth module 1225, the GNSS module 1227, or the NFC module 1228 may transmit/receive RF signals through a separate RF module.

The SIM 1224 may be an embedded SIM and/or a card containing the SIM 1224, and may include unique identification information (e.g., an integrated circuit card identifier (ICCID)) or subscriber information (e.g., international mobile subscriber identity (IMSI)).

The memory 1230 may include, for example, an internal memory 1232 or an external memory 1234. The internal memory 1232 may include at least one of a volatile memory (e.g., a dynamic RAM (DRAM), a static RAM (SRAM), a synchronous dynamic RAM (SDRAM), or the like), a nonvolatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash memory, a NOR flash memory, or the like)), a hard drive, or a solid state drive (SSD).

The external memory 1234 may include a flash drive such as a compact flash (CF), a secure digital (SD), a Micro-SD, a Mini-SD, an extreme digital (xD), a multimediacard (MMC), a memory stick, or the like. The external memory 1234 may be operatively and/or physically connected to the electronic device 1201 through various interfaces.

The sensor module 1240 may, for example, measure physical quantity or detect an operation state of the electronic device 1201 so as to convert measured or detected information into an electrical signal. The sensor module 1240 may include, for example, at least one of a gesture sensor 1240A, a gyro sensor 1240B, a barometric pressure sensor 1240C, a magnetic sensor 1240D, an acceleration sensor 1240E, a grip sensor 1240F, a proximity sensor 1240G, a color sensor 1240H (e.g., a red/green/blue (RGB) sensor), a biometric sensor 1240I, a temperature/humidity sensor 1240J, an illumination sensor 1240K, or an ultraviolet (UV) sensor 1240M. Additionally or alternatively, the sensor module 1240 may include, for example, an olfactory sensor (e-nose sensor), an electromyography (EMG) sensor, an electroencephalogram (EEG) sensor, an electrocardiogram (ECG) sensor, an infrared (IR) sensor, an iris recognition sensor, and/or a fingerprint sensor. The sensor module 1240 may further include a control circuit for controlling at least one sensor included therein. The electronic device 1201 may further include a processor configured to control the sensor module 1240 as a part of the processor 1210 or separately, so that the sensor module 1240 is controlled while the processor 1210 is in a sleep state.

The input device 1250 may include, for example, a touch panel 1252, a (digital) pen sensor 1254, a key 1256, or an ultrasonic input device 1258. The touch panel 1252 may employ at least one of capacitive, resistive, infrared, and ultraviolet sensing methods. The touch panel 1252 may further include a control circuit. The touch panel 1252 may further include a tactile layer so as to provide a haptic feedback to a user.

The (digital) pen sensor 1254 may include, for example, a sheet for recognition which is a part of a touch panel or is separate. The key 1256 may include, for example, a physical button, an optical button, or a keypad. The ultrasonic input device 1258 may sense ultrasonic waves generated by an input tool through a microphone 1288 so as to identify data corresponding to the ultrasonic waves sensed.

The display 1260 may include a panel 1262, a hologram device 1264, or a projector 1266. The panel 1262 may have a configuration that is the same as or similar to that of the display 1160 of FIG. 11. The panel 1262 may be, for example, flexible, transparent, or wearable. The panel 1262 and the touch panel 1252 may be integrated into a single module. The hologram device 1264 may display a stereoscopic image in a space using a light interference phenomenon. The projector 1266 may project light onto a screen so as to display an image. The screen may be disposed in the inside or the outside of the electronic device 1201. The display 1260 may further include a control circuit for controlling the panel 1262, the hologram device 1264, or the projector 1266.

The interface 1270 may include, for example, an HDMI 1272, a USB 1274, an optical interface 1276, or a D-subminiature (D-sub) 1278. The interface 1270, for example, may be included in the communication interface 1170 illustrated in FIG. 11. Additionally or alternatively, the interface 1270 may include, for example, a mobile high-definition link (MHL) interface, an SD card/MMC interface, or an infrared data association (IrDA) interface.

The audio module 1280 may convert, for example, a sound into an electrical signal or vice versa. At least a portion of elements of the audio module 1280 may be included in the input/output interface 1150 illustrated in FIG. 11. The audio module 1280 may process sound information input or output through a speaker 1282, a receiver 1284, an earphone 1286, or the microphone 1288.

The camera module 1291 is, for example, a device for shooting a still image or a video. The camera module 11091 may include at least one image sensor (e.g., a front sensor or a rear sensor), a lens, an image signal processor (ISP), or a flash (e.g., a light emitting diode (LED) or a xenon lamp).

The power management module 1295 may manage power of the electronic device 1201. The power management module 1295 may include a power management integrated circuit (PMIC), a charger integrated circuit (IC), or a battery gauge. The PMIC may employ a wired and/or wireless charging method. The wireless charging method may include, for example, a magnetic resonance method, a magnetic induction method, an electromagnetic method, or the like. An additional circuit for wireless charging, such as a coil loop, a resonant circuit, a rectifier, or the like, may be further included. The battery gauge may measure, for example, a remaining capacity of the battery 1296 and a voltage, current or temperature thereof while the battery is charged. The battery 1296 may include, for example, a rechargeable battery and/or a solar battery.

The indicator 1297 may display a specific state of the electronic device 1201 or a part thereof (e.g., the processor 1210), such as a booting state, a message state, a charging state, or the like. The motor 1298 may convert an electrical signal into a mechanical vibration, and may generate a vibration or haptic effect. Although not illustrated, a processing device (e.g., a GPU) for supporting a mobile TV may be included in the electronic device 1201. The processing device for supporting a mobile TV may process media data according to the standards of digital multimedia broadcasting (DMB), digital video broadcasting (DVB), MediaFLO™, or the like.

Each of the elements described herein may be configured with one or more components, and the names of the elements may be changed according to a type of an electronic device. An electronic device may include at least one of the elements described herein, and some elements may be omitted or other additional elements may be added. Furthermore, some of the elements of the electronic device may be combined with each other so as to form one entity, so that the functions of the elements may be performed in the same manner as before the combination.

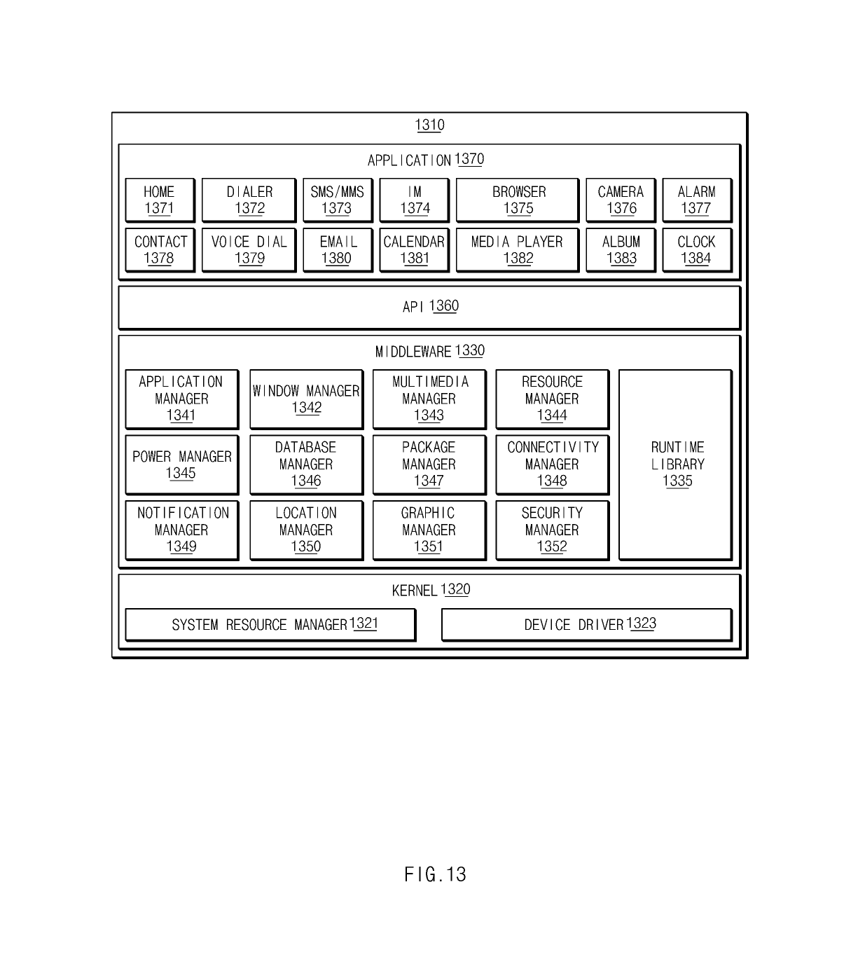

FIG. 13 is a diagram illustrating a program module, according to an embodiment of the present disclosure.

Referring to FIG. 13, a program module 1310 (e.g., the program 1140) may include an operating system (OS) for controlling a resource related to an electronic device (e.g., the electronic device 1101) and/or various applications (e.g., the application program 1147) running on the OS. The operating system may be, for example, Android™, iOS™, Windows™, Symbian™, Tizen™, or the like.

The program module 1310 may include a kernel 1320, a middleware 1330, an API 1360, and/or an application 1370. At least a part of the program module 1310 may be preloaded on an electronic device or may be downloaded from the first electronic device 1102, the second external electronic device 1104, or the server 1106.

The kernel 1320 may include, for example, a system resource manager 1321 or a device driver 1323. The system resource manager 1321 may perform control, allocation, or retrieval of a system resource. The system resource manager 1321 may include a process management unit, a memory management unit, a file system management unit, or the like. The device driver 1323 may include, for example, a display driver, a camera driver, a Bluetooth driver, a shared memory driver, a USB driver, a keypad driver, a Wi-Fi driver, an audio driver, or an inter-process communication (IPC) driver.

The middleware 1330, for example, may provide a function that the applications 1370 require in common, or may provide various functions to the applications 1370 through the API 1360 so that the applications 1370 may efficiently use limited system resources in the electronic device. The middleware 1330 may include at least one of a runtime library 1335, an application manager 1341, a window manager 1342, a multimedia manager 1343, a resource manager 1344, a power manager 1345, a database manager 1346, a package manager 1347, a connectivity manager 1348, a notification manager 1349, a location manager 1350, a graphic manager 1351, and a security manager 1352.

The runtime library 1335 may include, for example, a library module that a complier uses to add a new function through a programming language while the application 1370 is running. The runtime library 1335 may perform a function for input/output management, memory management, or an arithmetic function.

The application manager 1341 may mange, for example, a life cycle of at least one of the applications 1370. The window manager 1342 may manage a GUI resource used in a screen. The multimedia manager 1343 may recognize a format required for playing various media files and may encode or decode a media file using a codec matched to the format. The resource manager 1344 may manage a resource such as a source code, a memory, or a storage space of at least one of the applications 1370.

The power manager 1345, for example, may operate together with a basic input/output system (BIOS) to manage a battery or power and may provide power information required for operating the electronic device. The database manager 1346 may generate, search, or modify a database to be used in at least one of the applications 1370. The package manager 1347 may manage installation or update of an application distributed in a package file format.

The connectivity manger 1348 may manage wireless connection of Wi-Fi, Bluetooth, or the like. The notification manager 1349 may display or notify an event such as message arrival, appointments, and proximity alerts in such a manner as not to disturb a user. The location manager 1350 may manage location information of the electronic device. The graphic manager 1351 may manage a graphic effect to be provided to a user or a user interface related thereto. The security manager 1352 may provide various security functions required for system security or user authentication. In the case in which an electronic device includes a phone function, the middleware 1330 may further include a telephony manager for managing a voice or video call function of the electronic device.

The middleware 1330 may include a middleware module for forming a combination of various functions of the above-mentioned elements. The middleware 1330 may provide a module specialized for each type of an operating system to provide differentiated functions. Furthermore, the middleware 1330 may delete a part of existing elements or may add new elements dynamically.

The API 1360 which is, for example, a set of API programming functions may be provided in different configurations according to an operating system. For example, in the case of Android™ or iOS™, one API set may be provided for each platform, and, in the case of Tizen™, at least two API sets may be provided for each platform.

The application 1370, for example, may include at least one application capable of performing functions such as a home 1371, a dialer 1372, an SMS/MMS 1373, an instant message (IM) 1374, a browser 1375, a camera 1376, an alarm 1377, a contact 1378, a voice dial 1379, an e-mail 1380, a calendar 1381, a media player 1382, an album 1383, a clock 1384, health care (e.g., measure an exercise amount or blood sugar level), or environmental information provision (e.g., provide air pressure, humidity, or temperature information).

The application 1370 may include an information exchange application for supporting information exchange between the electronic device 1101) and the first electronic device 1102 or the second external electronic device 1104. The information exchange application may include, for example, a notification relay application for relaying specific information to the external electronic device or a device management application for managing the external electronic device.

For example, the notification relay application may have a function for relaying, to the first electronic device 1102 or the second external electronic device 1104, notification information generated in another application (e.g., an SMS/MMS application, an e-mail application, a health care application, an environmental information application, or the like) of the electronic device. Furthermore, the notification relay application may receive notification information from the external electronic device and may provide the received notification information to the user.

The device management application, for example, may manage (e.g., install, delete, or update) at least one function (e.g., turn-on/turn off of the external electronic device itself (or some elements) or the brightness (or resolution) adjustment of a display) of the first electronic device 1102 or the second external electronic device 1104 communicating with the electronic device, an application running in the external electronic device, or a service (e.g., a call service, a message service, or the like) provided from the external electronic device.

The application 1370 may include a specified application (e.g., a healthcare application of a mobile medical device) according to an attribute of the first electronic device 1102 or the second external electronic device 1104. The application 1370 may include an application received from the first electronic device 1102 or the second external electronic device 1104. The application 1370 may include a preloaded application or a third-party application downloadable from a server. The names of the elements of the program module 1310 illustrated may vary with the type of an operating system.

At least a part of the program module 1310 may be implemented with software, firmware, hardware, or a combination thereof. At least a part of the program module 1310, for example, may be implemented (e.g., executed) by a processor (e.g., the processor 1210). At least a part of the program module 1310 may include, for example, a module, a program, a routine, sets of instructions, or a process for performing at least one function.

At least a part of devices (e.g., modules or functions thereof) or methods (e.g., operations) may be implemented as instructions stored in a non-transitory computer-readable storage medium in the form of a program module. In the case where the instructions are performed by the processor 1120, the processor may perform functions corresponding to the instructions. The non-transitory computer-readable storage medium may be, for example, the memory 1130.

The non-transitory computer-readable recording medium may include a hard disk, a floppy disk, a magnetic medium (e.g., a magnetic tape), an optical medium (e.g., CD-ROM, digital versatile disc (DVD)), a magneto-optical medium (e.g., a floptical disk), or a hardware device (e.g., a ROM, a RAM, a flash memory, or the like). The program instructions may include machine language codes generated by compilers and high-level language codes that can be executed by computers using interpreters. The above-mentioned hardware device may be configured to be operated as one or more software modules for performing operations of various embodiments of the present disclosure and vice versa.

For example, an electronic device may include a processor and a memory for storing computer-readable instructions. The memory may include instructions for performing the above-mentioned various methods or functions when executed by the processor.

A module or a program module may include at least one of the above-mentioned elements, or some elements may be omitted or other additional elements may be added. Operations performed by the module, the program module or other elements may be performed in a sequential, parallel, iterative or heuristic way. Furthermore, some operations may be performed in another order or may be omitted, or other operations may be added.

In accordance with the methods and apparatuses that perform these methods described herein, even though a user purchases a new terminal or temporarily utilizes another terminal, the user may build a use environment, which the user wants, through a simple configuration while maintaining data previously stored in the user terminal.

While the present disclosure has been shown and described with reference to certain embodiments thereof, it will be understood by those skilled in the art that various changes in form and details may be made therein without departing from the scope of the present disclosure. Therefore, the scope of the present disclosure should not be defined as being limited to the embodiments, but should be defined by the appended claims and equivalents thereof.

What is claimed is:

1. An electronic device comprising:
a memory having a first memory area for storing an instruction that provides a normal operating mode and a second memory area for storing an instruction that provides a secure operating mode; and
a processor configured to implement a secure mode management module that is configured to receive configuration information associated with the secure operating mode from at least one external electronic device and to store at least one function corresponding to the configuration information in the second memory area.

2. The electronic device of claim 1, wherein the configuration information is obtained based on a user account.

3. The electronic device of claim 1, wherein the configuration information comprises application information, a security policy, a hardware configuration, and a data synchronization level that are used in the secure operating mode.

4. The electronic device of claim 1, wherein the secure mode management module is further configured to determine whether user information corresponding to the secure operating mode is different from user information corresponding to the electronic device and to execute and provide the at least one function remotely based on the determination.

5. The electronic device of claim 1, wherein the secure mode management module is further configured to verify a change of a user account corresponding to the secure operating mode, to receive another configuration information corresponding to the changed user account based on the verification, to store at least another function corresponding to the another configuration information in the second memory area, and to provide the at least another function based on the another configuration information.

6. An electronic device comprising:
a communication module configured to receive configuration information associated with at least one control operating mode from an external electronic device; and
a processor configured to control a control mode management module that is configured to provide at least one function corresponding to the configuration information if a resource of the electronic device satisfies the configuration information and to provide the at least one function based on one of the resource and the configuration information if the resource of the electronic device does not satisfy the configuration information.

7. The electronic device of claim 6, wherein the control operating mode comprises one of a normal operating mode and a secure operating mode.

8. The electronic device of claim 6, wherein the configuration information comprises application information, a security policy, a hardware configuration, and a data synchronization level that are used in the control operating mode.

9. The electronic device of claim 6, wherein the resource comprises one of a memory capacity, a communication speed, a processing speed, and hardware specifications corresponding to the electronic device.

10. The electronic device of claim 6, wherein the configuration information comprises an execution method of at least one application, and
wherein the control mode management module is further configured to install the at least one application in the electronic device if the execution method is a method that the electronic device executes and to designate another electronic device, which executes the at least one application, if the execution method is a method that the other electronic device executes.

11. The electronic device of claim 10, wherein the other electronic device comprises an external device operatively connected through one of a web app providing server and a local area communication module.

12. The electronic device of claim 10, wherein the other electronic device is a wearable device that is connected with the electronic device through a Bluetooth communication module.

13. The electronic device of claim 6, wherein in response to a change in a resource usage state, the control mode management module is configured to provide the at least one function based on the configuration information if the change in a resource usage state satisfies the configuration information and to provide the at least one function based on one of the changed resource and the configuration information if the change does not satisfy the configuration information.

14. The electronic device of claim 6, wherein the configuration information comprises information relating to one of a web based application and a local based application, and
wherein the web based application and the local based application are configured to be displayed differently in the at least one control operating mode.

15. A method of an electronic device, the method comprising:
executing a container for an operating environment of the electronic device;
obtaining configuration information associated with the container from an external electronic device; and
configuring the operating environment of the container based on the configuration information.

16. The method of claim 15, wherein the container comprises one of a normal operating mode container and a secure operating mode container.

17. The method of claim 15, wherein obtaining the configuration information comprises:
obtaining authentication information, and
downloading the configuration information corresponding to the authentication information from a server.

18. The method of claim 17, wherein the configuration information comprises an execution method of at least one application, and
wherein configuring of the operating environment comprises:
installing the at least one application in the container if the execution method is a method that the electronic device executes, and
designating another electronic device, which is to execute the at least one application, if the execution method is a method that the other electronic device executes.

19. The method of claim 17, wherein the configuration information comprises at least one function, and
wherein in response to a change in a resource usage state, configuring the operating environment comprises:
providing the at least one function based on the configuration information if the change in the resource usage state satisfies the configuration information, and
providing the at least one function based on one of the changed resource and the configuration information if the change in the resource usage state does not satisfy the configuration information.

20. A non-transitory computer-readable recording medium having recorded thereon an instruction, the instruction, when executed by an electronic device performing a method, the method comprising:
executing a container for an operating environment of the electronic device;
obtaining configuration information associated with the container from an external electronic device; and
configuring the operating environment of the container based on the configuration information.
